(19) United States
(12) Patent Application Publication
(10) Pub. No.: US 2025/0337844 A1
(43) Pub. Date: Oct. 30, 2025

(54) INFORMATION PROVISION SYSTEM, AND CONTROL METHOD FOR INFORMATION PROVISION SYSTEM

(71) Applicant: CANON KABUSHIKI KAISHA, Tokyo (JP)

(72) Inventor: SATOSHI TAMURA, Kanagawa (JP)

(21) Appl. No.: 19/177,929

(22) Filed: Apr. 14, 2025

(30) Foreign Application Priority Data
Apr. 26, 2024 (JP) 2024-072296

(51) Int. Cl. H04N 1/00

(52) U.S. Cl. CPC H04N 1/00063; H04N 1/00068

(57) ABSTRACT

An information provision system providing information relating to a procedure for a printer has a repair process display unit configured to provide information including one or more corresponding locations in the printer for which it has been estimated that a procedure is recommended, and procedure contents for the procedures with respect to the one or more corresponding locations; wherein the repair process display unit performs the provision of information such that a unit part for which the procedure is recommended, and a sub part for which the procedure is recommended and that is included in the unit part are both displayed independently as the corresponding locations.

### BACKGROUND OF THE INVENTION

### Field of the Invention

The present invention relates to an information provision system and a control method for an information provision system.

### Description of the Related Art

Conventionally, it has been possible to construct systems that perform the management of the information for and the state of a device such as a printer and the like (referred to below as a device). In such a system, when damage occurs in the device, it is possible to manage the occurrence state for the damage (when, for what device, and what kind of error has occurred) by a server receiving a notification of the damage that is transmitted from the device. In addition, an arrangement that provides a part that is a candidate for repairing the damage is proposed. Maintenance work for a device that is in an error state is implementing some kind of procedure such as replacing, cleaning, adjusting, and the like to one of the many parts of the device, and thereby resolving the error state. There are many cases in which the subject for which procedures should be implemented is a device that is configured by parts that are the smallest unit for which procedures are recommended (sub parts), and units, which are groupings of these sub parts. Japanese Unexamined Patent Application, First Publication No. 2011-221058 discloses an image forming device in which when information relating to a part is displayed on a display unit of the device, the unit for the part that is being displayed (a unit of a unit/a unit of a part) is made to be different based on information for who will replace the part (the user/a maintenance worker).

However, in Japanese Unexamined Patent Application, First Publication No. 2011-221058, the unit of display for a part is distinguished according to the person who will replace the part, and therefore, in a case in which a display is only performed at the unit of a unit, even in a case in which the majority of the procedure is taken up by a procedure for a particular sub part from among this unit, this part is not specified. In contrast, in a case in which display is performed at the unit of a sub part, all of the parts are displayed at the unit of a sub part regardless of the number of sub parts for which procedures will actually be carried out. Therefore, there are cases in which the number of parts that are displayed becomes excessive, and the person who will replace the parts is not made aware of which of the parts have the highest possibility of needing the procedures to be carried out from a statistical point of view from among this excessive number of parts. In this context, it is necessary to make it such that the person who is implementing the maintenance can understand for which part the procedure should be implemented without being aware of whether this part is a unit part or a sub part.

### SUMMARY OF THE INVENTION

The present disclosures makes it such that the person who will implement the maintenance on the device is able to clearly understand on which part the procedure should be performed.

The information provision system of the present disclosure is an information provision system providing information relating to a procedure for an image forming device, the information provision system comprising: a memory storing instructions; and a processor executing the instructions causing the information processing system to: provide information including one or more corresponding locations in the image forming apparatus for which it has been estimated that a procedure is recommended, and procedure contents for the procedure with respect to the one or more corresponding locations, wherein provision of information is performed such that a unit part for which the procedure is recommended, and a sub part for which the procedure is recommended and that is included in the unit part are both displayed independently as the corresponding locations.

Further features of the present invention will become apparent from the following description of exemplary embodiments with reference to the attached drawings.

### BRIEF DESCRIPTION OF THE DRAWINGS

FIG. 1 is a diagram showing an overall configuration for a system.

FIGS. 2A, and B are diagrams showing hardware configurations.

FIG. 3 is a diagram showing a software configuration.

FIG. 4 is a flowchart showing a repair location estimation flow.

FIG. 5 is a flowchart showing a repair location estimation flow.

FIG. 6 is a diagram showing one example of a recommended procedure screen for a case in which there is no recommended sub part.

FIG. 7 is a diagram showing one example of a recommended procedure screen for a case in which there is a recommended sub part.

FIG. 8 is a diagram showing detailed information for a recommended sub part.

FIG. 9 is a diagram showing detailed information for a unit part to which a recommended sub part belongs.

FIG. 10 is a diagram showing one example of a recommended procedure screen for a case in which there is no recommended sub part in a Second Embodiment.

FIG. 11 is a diagram showing one example of a recommended procedure screen for a case in which there is a recommended sub part in the Second Embodiment.

FIG. 12 is a flowchart showing a processing flow for unit of display change processing in a Second Embodiment.

### DESCRIPTION OF THE EMBODIMENTS

### First Embodiment

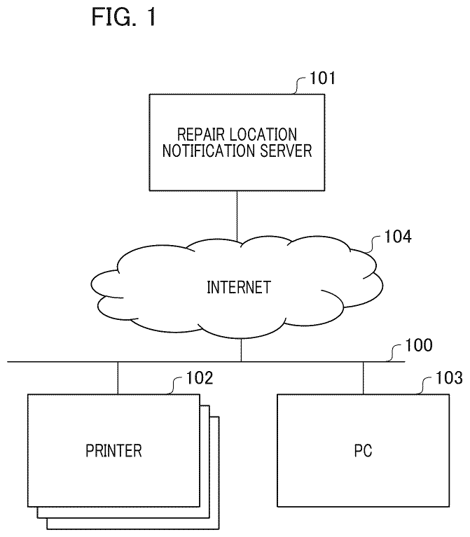

FIG. 1 is a block diagram showing a configuration of an information provision system. An information provision system (a repair location notification system) is a system that collects device operation information including error information and the like from an image forming device via a network, and provides information for recommended repair locations (corresponding locations) and recommended procedures to an engineer and the like who is in charge of the repairs. The information provision system has a repair location notification server 101 that provides a repair location notification service, a printer 102, which is a device that is the error detection target, and a PC 103, which is a terminal that receives information provision from the repair location notification service. These are communicably connected to each other via a network 100. For example, the network 100 includes an internet 104, and the repair location notification server 101 performs communications with the printer 102 and the PC 103 via the internet 104. Note that it is sufficient if the network 100 is configured so as to be able to send and receive data, and the communications format is not limited. For example, the network 100 is configured from one of a cellular network such as LAN, WAN, LTE, 5G, and the like, a wireless network, a telephone line, a digital leased line, and the like, or a combination thereof.

The repair location notification server 101 provides a repair location notification service that provides the PC 103, which is used by the engineer, with error information showing an error that has occurred in the printer 102, and data for outputting a recommended repair location and procedure information for resolving the error. The repair location notification server 101 first receives error information from the printer 102 showing error information for an error that occurred in the printer 102, and estimates one or more pieces of repair part information for resolving this error. Furthermore, the repair location notification server 101 manages a record of procedures that have been performed in the market for the same error in the past as a market record, and determines a degree of priority for repair parts that should be the subject of the procedure based on the market record. Note that although in the present embodiment, an example is explained in which the procedure for the error is estimated based on the market record, the present disclosure is not limited thereto, and for example, it may also be made such that the procedure for the error is estimated using AI. This AI uses an already learned model for which information for work performed by a serviceman and for replacement parts has been collected, and machine learning has been performed based on this information, and then estimates the procedure. In addition, the repair location notification server 101 provides the PC 103 that is used by the customer engineer and the like who is in charge of repairing the printer 102 with error information, repair part information, information for processing to resolve the error, and the like. In addition, the repair location notification server 101 gathers feedback information from the customer engineer who performed the procedure for resolving the error.

The repair location notification server 101 is located on, for example, the internet 104. The repair location notification server 101 uses a cloud computing technology on the internet. In addition to one or more information processing apparatuses, the repair location notification server 101 may also be realized by a virtual machine (a cloud service) that uses resources that have been provided by a data center including an information processing apparatus, or a combination thereof. In addition, it is also possible to realize the information provision system as a web-based application, and it is also possible to use the information provision system via a web browser on the PC 103. In addition, the repair location notification server 101 may also be implemented by being separated into a data collection server that collects data such as error information and the like from the printer 103, and a repair location notification server that presents a recommended procedure by estimating a repair location based on the data that has been collected by the data collection server. In addition, the repair location notification server 101 may also be an on-premises system configuration that uses a physical server.

The printer 102 is one example of an image forming apparatus that is managed by an information provision system. There may also be a plurality of printers 102 that are managed by the information provision system. The image forming apparatus is not limited to a printer, and it is sufficient if the image forming apparatus is an apparatus having any of a printing function, a copy function, a scanning function, a network transmission function for data, and a fax function, such as an MFP that is provided with the functions of printing, faxing, copying, scanning, and the like, a scanner, a 3D printer, and the like. Upon detecting the occurrence of an error according to the device and an option device with which the device has been provided, the printer 102 transmits error information including device information to the repair location notification server 101.

The PC (personal Computer) 103 is one example of an information processing apparatus. The PC 103 has a specific OS installed. In addition, a browser 331, which will be described below, is installed on the PC 103. The PC 103 performs display of a screen that is provided by the repair location notification server 101 via the browser 331. For example, the PC 103 transmits an error information (alert information) acquisition request for the printer 102 to the repair location notification server 101 via the browser 331. In addition, the PC 103 receives error information and the like from the repair location notification server 101 as a response, and displays a GUI (Graphical User Interface). The PC 103 is used, for example, by a business that dispatches customer engineers (servicemen) who are in charge of maintaining (performing maintenance for) the printer 102. The engineer is able to perform a remote control operation on the printer 102 via a screen that is provided by the repair location notification server 101 and displayed on the browser 331 of the PC 103. Note that it is sufficient if the PC 103 is a terminal that is able to display a screen that is provided from the repair location notification server 101 via the network 100, and this may also be a tablet, a smartphone, and the like.

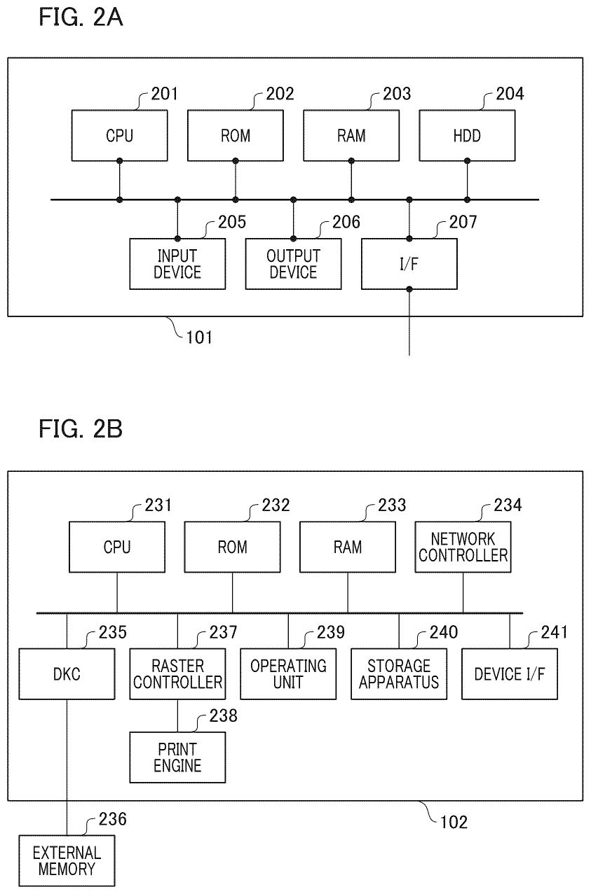

FIG. 2A is a diagram showing a hardware configuration for the repair location notification server 101. Note that the PC 103 and the repair location notification server 101 both have the same hardware configuration. The repair location notification server 101 has a CPU 201, a ROM 202, a RAM 203, an HDD 204, an input device 205, an output device 206, and a communications I/F 207. Each configurational element of the hardware is connected to a system bus.

The CPU (Central Processing Unit) 201 controls the entirety of the repair location notification server 101. The CPU 201 executes each type of control processing by reading out a control program that has been stored on the ROM 202 and the HDD 204. The ROM 202 (Read Only Memory) is a data read-only memory, and stores, for example, a basic control program for the information processing apparatus and the like such as a BIOS (Basic Input Output System), and the like. The RAM (Random Access Memory) 203 is a data readable/writable memory. For example, the RAM 203 functions as a work area and the like for the CPU 201. The HDD (Hard Disk Drive) 204 stores each type of data and program. Note that although an explanation is given in the present embodiment of an example in which the repair location notification server 101 is provided with the HDD 204 to serve as the storage device, the present disclosure is not limited thereto, and the repair location notification server 101 may also be provided with a different storage device such as for example, an SSD, a disk drive into which external media is inserted, and the like.

The input device 205 receives operations from the user. The input device 205 is connected to, for example, a keyboard and a pointing device, and the like. The output device 206 performs display to the user. The output device 206 is connected to, for example, a display such as a liquid crystal display and the like. The communications I/F 207 is an interface for connecting to the network 100. The repair location notification server 101 performs communications with an external device such as the printer 102, the PC 103, and the like, via the communications I/F 207, and the network 100.

After starting up the repair location notification server 101, the BIOS is executed by the CPU 201, and the OS is executably loaded onto the RAM 203 from the HDD 204. The CPU 201 executably loads each type of software module to be described below according to the operation of the OS onto to the RAM 203 from the HDD 204 at the same time. Each type of software module is executed and operated by the CPU 201 by cooperating with each type of device described above. In addition, the communications I/F 207 is connected to the network 100, is controlled by the CPU 201 according to the operations of the OS, and realizes communications.

FIG. 2B is a diagram showing a hardware configuration of the printer 102. The printer 102 has a CPU 231, a ROM 232, a RAM 233, a network controller 234, a DKC 235, a raster controller 237, a print engine 238, an operating unit 239, a storage device 240, and a device I/F. The parts from among these other than the print engine 238 are also referred to as a controller that manages the control system of the printer. Each configurational element of the hardware is connected to a system bus.

The CPU 231 performs control of the entirety of the printer 102, and integrally controls access to each type of device that is connected to the system bus. The CPU 231 executes each type of control processing by reading out a control program and the like that has been stored on the ROM 232 or a control program and resource data (resource information) that have been stored on an external memory 236 that has been connected to a disk controller (the DKC 235).

The ROM 232 stores a program that is executed by the CPU 231. The RAM 233 functions as the primary memory, work area, and the like of the CPU 231. The RAM 233 is configured so as to be able to expand the memory capacity using an option RAM that is connected to an expansion port that is not shown. The storage device 240 is a storage means that functions as a mass memory. The storage device 240 stores image data, each type of program, and each type of setting information.

The network controller 234 is a communications controller, and is, for example, a network interface card (NIC). The CPU 231 performs data exchanges with external devices on the network 100 via the network controller 234. The DKC 235 controls access to storage devices such as the external memory 236, and the like. The external memory 236 stores programs and resource data.

The operating unit 239 displays a screen and also receives operating commands from the user via the screen. For example, the operating unit 239 is a touch panel. This touch panel displays settings such as the operating mode for the printer 102, and the like, and the operating state of the printer 102. By correlating input coordinates and display coordinates on the touch panel, it is possible to configure a GUI such that it is possible for the user to directly operate a screen that has been displayed on the touch panel. In addition, a button for performing settings such as the operation mode of the printer 102, and the like, and operations to indicate content data to be printed may also be placed on the operating unit 239.

The raster controller 237 is a controller that converts print data that has been described using, for example, a PDL language, into image data. The print engine 238 forms images on a recording medium (for example, paper) based on image data that is input from the raster controller 237 using a well-known printing technology. The format of the printing performed by the print engine 238 is, for example, an electrophotographic format (a laser beam format) and an inkjet format, a sublimation (thermal transfer) method, and the like, and the format thereof is not limited. The device I/F 241 is a connection I/F for external devices that are connectable by USB and the like.

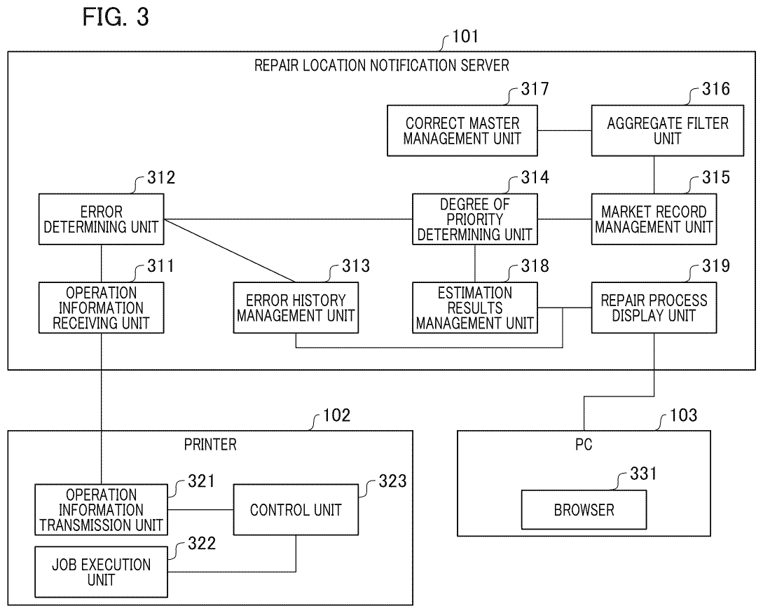

FIG. 3 is a diagram showing a software configuration of the information provision system. This software configuration is realized by programs that have been stored on the memories of each device being executed by the CPU. Note that the schema and data in the tables explained below are simply one example, and the present disclosure is not limited to the formats for the schema and for each type of data in the tables. The repair location notification server 101 has an operation information receiving unit 311, an error determining unit 312, an error history management unit 313, and a degree of priority determining unit 314. The repair location notification server 101 further has a market record management unit 315, an aggregate filter unit 316, a correct master management unit 317, an estimation results management unit 318, a repair process display unit 319, and a feedback management unit 320.

The operation information receiving unit 311 receives operation information from the printer 102. The information that is received by the operation information receiving unit 311 includes information for identifying a device, error information based on the occurrence of an error (event information), and information showing the operation state of the printer 102 such as the number of pages printed in the printer 102, the remaining quantity of consumable products, and the like. The information for identifying a device that is included in the operation information includes, for example, a device ID that uniquely identifies a device, and a model number that shows the device type. The error information is, for example, an error code for identifying the type of error. The error code is a unique alphanumerical code that has been assigned to each type of error. The operation information receiving unit 311 transmits the operation information to the error determining unit 312 in a case in which error information has been included in the operation information.

The error determining unit 312 performs error determination that estimates a cause for an error based on the error information. Upon receiving the error information from the operation information receiving unit 311, an error history, which shows error information that has previously occurred in the printer that transmitted the error information, is acquired from the error history management unit 313. In addition, the error determining unit 312 estimates one or more parts that are the cause of the error, that is, one or more repair pairs for resolving this error, based on the error information that has been received. The error determining unit 312 handles the repair parts that have been specified in order to resolve the error and the possibility of damage thereto as the error determination results. The error determining unit 312 outputs the one or more repair parts for resolving the error, which are the results that have been estimated, along with the error information to the degree of priority determining unit 314 at the unit of a unit part. In addition, the error determining unit 312 stores the error information that has been received from the printer 102 in the error history management unit 313 to serve as the error history. The error determining unit 312 performs error determination according to, for example, a rule-based estimation engine. Note that although an example has been explained in which the error determining unit 312 performs estimation using a rule base, the present disclosure is not limited thereto. For example, the error determining unit 312 may also perform estimation of the repair part using mechanical learning including deep learning.

As the repair parts there are “unit parts” and “sub parts”. The “unit parts” are primary parts that configure the printer 102. The “sub parts” are parts at a more detailed unit that configure the unit parts. That is, a unit part is a group of sub parts, and the unit parts are related to the sub parts such that they include the sub parts. Note that a “sub part” may also be further configured by a plurality of parts. In addition, there may also be sub parts that are shared by a plurality of unit parts. The error determining unit 312 outputs repair parts at the unit of a “unit part” when outputting the determination results to the degree of priority determining unit 314.

The error determining unit 312 outputs a list of repair parts to serve as the determination results. Table 1 is an example of determination results that are output by the error determining unit 312.

TABLE 1
Part Number

Unit 1
Unit 2
Unit 3

The determination results include the cause for the error that occurred in the printer 102 as well as a part number at the unit of a unit part that uniquely identifies a repair part that has been estimated. In the example of Table 1, three unit parts are listed, the unit 1, the unit 2, and the unit 3, as the damaged parts. In addition, the error determining unit 312 may also be made so as to estimate how high or low the possibility of damage is to the damaged parts that have been estimated, and to output the list of repair parts by adding information with respect to how high or low the possibility of damage is for the damaged parts that have been estimated thereto. For example, the possibility of damage is shown as high or low. Note that the error determining unit 312 makes the determination results “a repair part cannot be specified” in a case in which a repair part cannot be specified when an error cannot be specified based on the error information that has been received (error code), and the like.

The error history management unit 313 stores and manages the error information that has been received from the printer 102 to serve as an error history. Table 2 is one example of an error history that is managed by the error history management unit 313.

TABLE 2

| | | Model | Error | Counter | Date and Time |
|---|---|---|---|---|---|
| Error ID | Device ID | Number | Code | Value | of Occurrence |
| Err-001 | DEV001 | Model-001 | E001- | 5000 | 2022-10- |
| | | | 0001 | | 01T12:34:56Z |
| Err-002 | DEV002 | Model-002 | E002- | 1500 | 2022-09- |
| | | | 0002 | | 03T00:00:00Z |
| Err-003 | DEV001 | Model-001 | E003- | 2000 | 2022-09- |
| | | | 0001 | | 01T00:12:34Z |

The error history includes an error ID that uniquely identifies an error, a device ID that uniquely identifies the printer in which the error occurred, a model number that shows a device type, an error code that indicates the type of error that occurred, a counter value, which is the number of sheets printed at the time of the occurrence of the error, and the date and time at which an error occurred.

The degree of priority determining unit 314 estimates the degree of priority for the processes for the procedures (the maintenance response) that should be implemented in order to resolve the error that is occurring in the printer 102. Specifically, upon receiving the determination results from the error determining unit 312, the degree of priority determining unit 314 acquires a market record for which the model number and the error code matches the model number and the error code for the error information that is included in the determination results from the market record management unit 315. The degree of priority determining unit 314 ranks the repair processes based on the market record. The degree of priority determining unit 314 stores the repair processes that it has ranked to serve as the estimation results in the estimation results management unit 318. The estimation results for the repair parts that have been estimated by the degree of priority determining unit 314 will be described below using Table 4.

The market record management unit 315 stores and manages two types of aggregate results with respect to all of the procedures that have been implemented in order to resolve errors that have previously occurred. One of these is an aggregate relating to the number of replacement parts (a market replacement record), which aggregates the number of parts replaced per model number, error code, and part number. The other is an aggregate relating to the procedures, which aggregates the procedures that have been implemented per model number, and error code. The market record management unit 315 collects record information including the procedures and the like per model number, error code, and part number from the customer engineer who performed the procedure to resolve the error, and aggregates the number of records per part and per procedure, then stores and manages the aggregate results.

Table 3 is one example of a market replacement record, which is an aggregate of the number of replaced parts for the market record that is managed by the market record management unit 315. Note that the aggregate related to the procedures will be explained below in Table 5 and Table 6.

TABLE 3

| | | | Number of |
|---|---|---|---|
| Model | | Part | Replacements per |
| Number | Error Code | Number | Part |
| Model-001 | E001-0001 | Unit 1 | 127 |
| Model-001 | E001-0001 | Sub 1-1 | 8 |
| Model-001 | E001-0001 | Sub 1-2 | 20 |
| Model-001 | E001-0001 | Sub 1-3 | 74 |
| Model-001 | E001-0001 | Unit 2 | 7 |
| Model-001 | E001-0001 | Sub 2-1 | 21 |
| Model-001 | E001-0001 | Sub 2-2 | 349 |
| Model-001 | E001-0001 | Sub 2-3 | 3 |
| Model-001 | E001-0001 | Unit 3 | 108 |

The market record relating to the number of replaced parts includes a model number that shows the device type, an error code, which is the type of error that has occurred, a part number for the part that has been replaced in relation to the error, and a number of replacements, which is a number of part replacement records. Note that it is made such that as the part number, unit parts are displayed using “Unit”, and sub parts are displayed using “Sub”. In addition, Sub 1 shows a sub part within the Unit 1, and Sub 2 shows a sub part within the Unit 2.

The degree of priority determining unit 314 determines an order of priority for the repair parts based on the aggregate results for the number of replacement parts and the determination results of the error determining unit 312. For example, the degree of priority determining unit 314 orders the parts in the order of parts for which there are many procedures with market records for which the repair part and the part number match the repair part and the part number that are included in the determination result as repair parts that have a high possibility of resolving the error, and thereby sets the degree of priority. Table 4 is one example of estimation results for the repair parts that have been estimated by the degree of priority determining unit 314.

TABLE 4

| | | | | Number of | Probability |
|---|---|---|---|---|---|
| | | | | Replace- | of Being the |
| Degree of | Device | | Part | ments | Cause of |
| Priority | ID | Error Code | Number | per Part | the Damage |
| 2 | DEV001 | E001-0001 | Unit 1 | 127 | 31.9% |
| | DEV001 | E001-0001 | Sub 1-1 | 8 | |
| | DEV001 | E001-0001 | Sub 1-2 | 20 | |
| | DEV001 | E001-0001 | Sub 1-3 | 74 | |
| 4 | DEV001 | E001-0001 | Unit 2 | 7 | 4.3% |
| | DEV001 | E001-0001 | Sub 2-1 | 21 | |
| 1 | DEV001 | E001-0001 | Sub 2-2 | 349 | 48.7% |
| | DEV001 | E001-0001 | Sub 2-3 | 3 | |
| 3 | DEV001 | E001-0001 | Unit 3 | 108 | 15.1% |

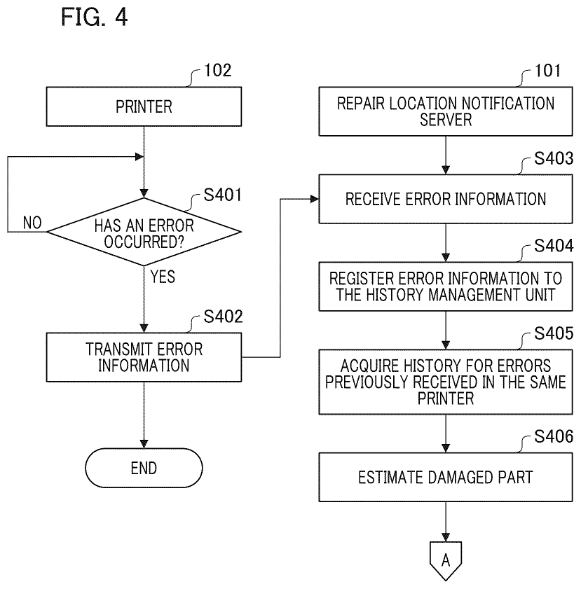

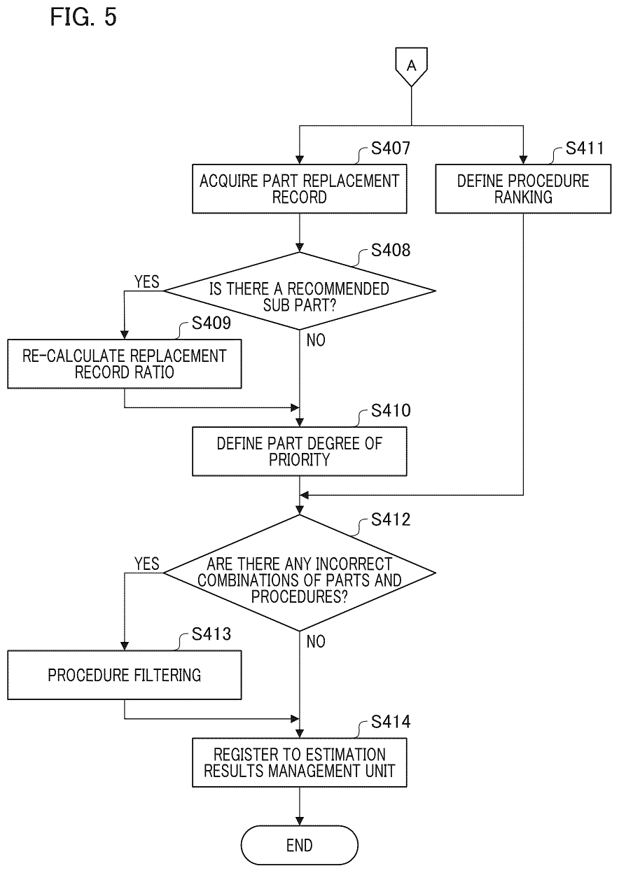

The estimation results include the device ID, the error code, the part number for the repair part corresponding to the error, a number of replacements per part, which is the part replacement record, a probability of being the cause of the damage, and a degree of priority that shows the ranking of the parts that should be repaired. An example of the calculation method for the degree of priority for a repair part will be explained below. Note that instead of the number of replacements per part serving as the part replacement record, or in addition to the number of replacements per part, a replacement record ratio that is calculated from the replacement number per part may also be prepared and included in the estimation results. In addition, although in the present embodiment, the narrowing down of parts is not performed using the estimation results of the error determining unit 312, it may also be made such that the narrowing down of parts is implemented, and only the parts that have been given a degree of priority, and the parts that have a higher probability of being the cause of the damage than a predetermined probability are handled as the estimation results. An example of the calculation method for the degree of priority will be explained in the repair part estimation processing from FIG. 4 and FIG. 5.

Table 5 is one example of a market procedure record, which is the aggregate of the procedures for the market records that are managed by the market record management unit 315.

TABLE 5

| Model | | | Replacement |
|---|---|---|---|
| Number | Error Code | Procedure | Part |
| Model-001 | E001-001 | Replace | Unit 1 |
| Model-001 | E001-001 | Adjust | |
| Model-001 | E001-001 | Clean | |
| Model-001 | E001-001 | Replace | Sub 1-1 |
| Model-001 | E001-001 | Adjust | |
| Model-001 | E002-002 | Clean | |
| Model-001 | E002-002 | Clean | |
| Model-001 | E002-002 | Adjust | |
| Model-001 | E003-003 | Replace | Sub 2-1 |
| Model-002 | E001-001 | Replace | Unit 3 |
| Model-002 | E003-003 | Clean | |

The market record relating to the procedures includes a model number, shows the device type, an error code, which is the type of error that has occurred, and procedures that have been implemented against the error. Furthermore, in a case in which the procedure that has been implemented is a replacement, a part number showing the part that has been replaced is included in the market record related to the procedures.

The degree of priority determining unit 314 determines the degree of priority ranking for the procedures for resolving the error based on the determination results for the error determining unit (Table 2), and the market procedure record (Table 5). Table 6 is one example of estimate results for procedures that are determined by the degree of priority determining unit 314. Table 6 shows the degree of priority ranking for processing in relation to an error for the model number Model-001 with an error code of E001-001.

TABLE 6

| | | | Degree of |
|---|---|---|---|
| Device ID | Error Code | Procedure | Priority |
| Dev001 | E001-001 | Replace | A |
| Dev001 | E001-001 | Adjust | A |
| Dev001 | E001-001 | Clean | B |

The estimation results for the procedures include the device ID, the error code, the procedures for resolving the error, and the degree of priority for each procedure. As the procedure for resolving the error, there is, for example, replacing the part (replace), adjustments to the part such as changing settings values, updating the firmware, and the like (adjust), cleaning the part (clean), and the like. The degree of priority determining unit 314 manages a combination of the estimation of the repair part for the procedure target that has been estimated to be the cause of the error and the estimation of the procedure for this repair part as one estimation result.

The correct master management unit 317 manages a correct master that defines combinations of logically correct parts and procedures. For example, the aggregate filter unit 316 excludes combinations that are not defined as being logically correct from the combinations of repair parts and procedures that have been obtained from the aggregate results for the market records for the procedures (Table 5), and the estimation results for the procedures (table 6) according to the definition of the correct master management unit 317.

The estimation results management unit 318 manages the degree of priority for the repair part that has been determined by the degree of priority determining unit 314 (Table 4) and the procedures (table 6) by combining them. Table 7 is one example of estimate results that are managed by the estimation results management unit 318.

TABLE 7

| | | | | | Probability | | | |
|---|---|---|---|---|---|---|---|---|
| | | | | | of Being | | | |
| Degree | | | | Number of | the Cause | | | |
| of | Device | Error | Part | Replacements | of the | | | |
| Priority | ID | Code | Number | per Part | Damage | Replace | Clean | Adjust |
| 2 | DEV001 | E001- | Unit 1 | 127 | 31.9% | A | B | |
| | | 0001 | | | | | | |
| | DEV001 | E001- | Sub 1-1 | 8 | | | | |
| | | 0001 | | | | | | |
| | DEV001 | E001- | Sub 1-2 | 20 | | | | |
| | | 0001 | | | | | | |
| | DEV001 | E001- | Sub 1-3 | 74 | | | | |
| | | 0001 | | | | | | |
| 4 | DEV001 | E001- | Unit 2 | 7 | 4.3% | A | B | A |
| | | 0001 | | | | | | |
| | DEV001 | E001- | Sub 2-1 | 21 | | | | |
| | | 0001 | | | | | | |
| 1 | DEV001 | E001- | Sub 2-2 | 349 | 48.7% | A | | |
| | | 0001 | | | | | | |
| | DEV001 | E001- | Sub 2-3 | 3 | | | | |
| | | 0001 | | | | | | |
| 3 | DEV001 | E001- | Unit 3 | 108 | 15.1% | | B | A |
| | | 0001 | | | | | | |

The estimation results that are managed by the estimation results management unit 318 include a degree of priority for a part, a device ID, an error code, a part number, a number of part replacements, which shows the replacement record, a probability of being the cause of the damage, and a degree of priority for each procedure (replace, clean, and adjust). Note that the columns for which the degree of priority and the degree of priority for each processing are empty are columns for which values are not defined.

The repair process display unit 319 provides information for displaying the recommended procedures screen (repair process display screen) via the browser 331 on the PC 103, which is viewed by the customer engineer. Specifically, upon receiving a repair process acquisition request that includes a device ID and an error ID from the browser 331 of the PC 103, the repair process display unit 319 acquires an error history for which the device ID and the error ID match the device ID and the error ID that were included in the request from the error history management unit 313. The repair process display unit 319 acquires estimation results for which the device ID and the error code match the device ID and the error code in the request from the estimation results management unit 318. In addition, the repair process display unit 319 generates a repair process display screen based on the error history and estimation results that have been acquired, and returns this to the browser 331 of the PC 103. In addition, after the customer engineer has executed the procedure (the maintenance response), the repair process display unit 319 may also generate a feedback information input screen for inputting execution results (feedback) and provide this to the browser 331.

The printer 102 has an operation information transmission unit 321, a job execution unit 322, and a control unit 323. The operation information transmission unit 321 transmits the operation information for the printer 102 including the information for errors that have occurred in the printer 102 that has been collected by the control unit 323 to the repair location notification server 101. The job execution unit 322 executes jobs that have been submitted to the printer 102. For example, in the case in which a print job has been submitted, the job execution unit 322 executes printing processing based on the print job. The control unit 323 collects the operation state for the printer 102, and transmits the operation state to serve as operation information to the repair location notification server 101 via the operation information transmission unit 321. For example, the control unit 323 detects an error that has occurred in the printer 102, collects error information, and transmits the error information to the repair location notification server 101 via the operation information transmission unit 321.

The PC 103 has the browser 331. The PC 103 transmits a repair part information acquisition request for the printer 102 to the repair location notification server 101 via the browser 331, receives repair part information from the repair location notification server 101 as an answer thereto, and displays this on the GUI. That is, the PC 103 displays a screen that is provided by the information provision system via the browser 331, which is a web browser.

Next, the processing for estimating procedures for resolving the error of the printer 102 will be explained (recommended procedure estimation processing). The results of the recommended procedure estimation processing are stored in the estimation results management unit 318, and in a case in which there has been a display request from the PC 103, the results of the recommended procedure estimation processing are provided to the customer engineer via the browser 331. FIG. 4 and FIG. 5 are flowcharts showing the recommended procedure estimation processing. During the recommended procedure estimation processing, the estimation results that are shown in Table 7 are ultimately calculated, and stored in the estimation results management unit 318. The processing that is executed by the printer 102 during the recommended procedure estimation processing is realized by the CPU 231 of the printer 102 reading out a program and resource data that have been stored on a memory (ROM 232, external memory 236, and the like) and executing the program. The processing that is executed by the repair location notification server 101 during the procedure estimation processing is realized by the CPU 201 of the repair location notification server 101 reading out a program and resource data that have been stored on a memory (ROM 202, HDD 204, and the like) and executing the program.

During S401, the control unit 323 of the printer 102 detects whether or not an error has occurred inside of the printer 102. Upon the control unit 323 detecting the occurrence of an error, the processing for S402 is performed. In contrast, in a case in which the occurrence of an error is not detected, the processing for S401 is repeated by the control unit 323. During S402, the operation information transmission unit 321 of the printer 102 transmits operation information including error information corresponding to the error that has been detected by the control unit 323 to the repair location notification server 101. Note that below, operation information that includes error information is also simply referred to as error information, The error information that is transmitted by the operation information transmission unit 321 includes, for example, an error ID that uniquely identifies an error, a device ID and model number that are information for a device, an error code showing an error, a counter value that is the number of sheets printed at the time of the occurrence of the error, and the date and time of the occurrence of the error. That is, the operation information transmission unit 321 of the printer 102 transmits information that is managed as the error history by the error history management unit 313 of the repair location notification server 101 to the repair location notification server 101. Note that although an example is described in the present embodiment in which the counter value is included in the error information, it may also be made such that, for example, the counter value is transmitted to the repair location notification server 101 as counter information, which is information that is separate from the error information. In a case in which the counter information has been transmitted separately from the error information, linking of the error information and the counter information is performed in the repair location notification server 101.

The processing for the service that is provided by the information provision system that includes the repair location notification server 101 (repair location notification service) is started with the reception of error information from the printer 102 as the trigger. During S403, the operation information reception unit 311 of the repair notification server 101 receives error information from the printer 102. During S404, the error determining unit 312 registers the error information that has been received from the printer 102 as error history in the error history management unit 313.

During S405, the error determining unit 312 acquires the error history that has been previously received from the printer 102 that was the transmission source for the error information that was received during S403 from among the error history (Table 2) that is managed by the error history management unit 313. Specifically, the error determining unit 312 acquires the error history for which the device ID matches the device ID that is included in the error information that was received from the printer 102 from the error history that is managed by the error history management unit 313. For example, in a case in which the device ID that is included in the error information is “DEV001”, the error determining unit 312 acquires the records for the first row and the third row from the error history that is shown in Table 2.

During S406, the error determining unit 312 performs estimation of the damaged part that is the cause of the error, that is, for the repair part for which the procedures should be performed in order to resolve the error. The error determining unit 312 estimates repair parts to which procedures should be performed in order to resolve the error by a rule-based method using the error information that has been received from the printer 102, and the error history that has been acquired from the error history management unit 313, and outputs a list of part numbers for the repair parts. The error determining unit 312 estimates damaged parts at the unit of a unit part, and outputs estimation results (for example, table 1). Although an example has been explained in the present embodiment of a rule-based method that uses the error information received by the error determining unit 312 and the error history of errors that have previously occurred in the same device, the specification of the repair parts is not limited thereto. For example, an estimation using machine learning with a teacher including deep learning may also be performed.

Upon the estimation results for the repair part being output during $406, the repair location notification server 101 parallelly performs the processing from $407 to S410 with the processing for S411. During S407, the degree of priority determining unit 314 performs the acquisition of the replacement ratio in the market record to serve as the market replacement ratio with respect to the repair part that has been estimated during S406. The replacement ratio is calculated at the unit of a unit part, the same as for the list of the repair parts. The degree of priority determining unit 314 acquires the number of part replacements for which the model number and the error code match the model number and the error code for the error information from the market replacement record (Table 3) that is managed by the market record management unit 315. For example, it is assumed that the model number that is included in the error information is “Model-001”, and the error code that is included in the error information is “E001-0001”. In this case, the degree of priority determining unit 314 acquires the records for all of the rows in Table 3 to serve as the market replacement record. The degree of priority determining unit 314 acquires the number of part replacements without distinguishing unit parts and sub parts. In addition, the degree of priority determining unit 314 calculates the replacement ratio at the unit of a unit part by lumping sub parts together with the number of replacements for the unit parts to which they belong.

During S408, the degree of priority determining unit 314 determines the presence or absence of a recommended sub part for which replacement is recommended. The degree of priority determining unit 314 uses the number of replacement records that was acquired during S407, and determines that there is a recommended sub part in a case in which the ratio in the overall number of replacement records for a unit part (including the sub parts of this unit part) that is taken up by the number of replacement records for a specific sub part exceeds a predetermined ratio. First, the degree of priority determining unit 314 determines the number of replacement records for this specific sub part from among the number of replacement records (including the replacement records for sub parts) for a specific unit part. In addition, the degree of priority determining unit 314 determines that a specific sub part is a recommended sub part in a case in which (the number of replacement records for a particular sub part)/(the total of the unit parts to which the particular sub part belongs and the number of replacement records for the sub parts that belong to this unit part) exceeds 90%. The determination during S408 is performed for all of the unit parts for which the number of replacement records has been acquired.

Using Table 3 as an example, the “Unit 1”, “Unit 2”, and “Unit 3” are unit parts. The “Sub 1-1”, “Sub 1-2”, and “Sub 1-3” are sub parts that belong to the “Unit 1”, while the “Sub 2-1”, “Sub 2-2”, and “Sub 2-3” are sub parts belong to the “Unit 2”. At this time, the number of replacement records for the “Unit 1”, which includes the sub parts that belong to the “Unit 1”, is 229, and no sub part exists among the sub parts that belong to the “Unit 1” for which the number of replacement records exceeds 90% of 229. In contrast, the number of replacement records for the “Unit 2”, including the sub parts that belong to the “Unit 2”, is 380, and the number of replacement records for the “Sub 2-2” is 349, which is 91.8% of 380. Therefore, in the example in Table 3, the “Sub 2-2” is determined to be the recommended sub part. No sub parts exist that belong to the “Unit 3”, and therefore, the degree of priority determining unit 314 does not execute a recommended sub part determination for the “Unit 3”.

In a case in which it has been determined during S408 that there is a recommended sub part for which replacement is recommended, the degree of priority determining unit 314 performs the processing for S409. In contrast, in a case in which it has been determined during S408 that there is no recommended sub part for which replacement is recommended, the degree of priority determining unit 314 performs the processing for S410. Note that although the threshold value with respect to the determination criteria for the recommended sub part is made 90% in the present embodiment, the present disclosure is not limited thereto, and it is sufficient if the threshold value is determined by taking into consideration the configuration of the parts, the characteristics of each part, the usage environment, and the like.

During S409, the degree of priority determining unit 314 excludes the recommended sub part from the unit part, and performs a re-calculation of the part replacement ratio. During S407, the part replacement ratio is calculated at the unit of a unit part, and at this time, the part replacement ratio has been calculated with the sub parts that belong to a unit part being included in that unit part. In relation to this, during S409, the recommended sub part that was identified during S408 is separated from the unit part, and the part replacement ratio is calculated. More specifically, the degree of priority determining unit 314 re-calculates the replacement record ratio for the unit part to which the recommended sub part belongs by removing the number of replacement records for the recommended sub part. Furthermore, the degree of priority determining unit 314 calculates the replacement record ratio for the sub part that was determined to be the recommended sub part individually for this sub part.

In the example of Table 4, there are no parts that have been determined to be recommended sub parts among the sub parts that belong to the “Unit 1”, and therefore, the replacement record ratio is calculated using the total value for the unit part itself and the sub parts that belong to this unit part. The “Unit 3” does not have any sub parts that belong to it, and therefore, the replacement record ratio is calculated using the total value for the unit part itself and the sub parts that belong to this unit part. In contrast, with respect to the “Unit 2”, for which it was determined that the “Sub 2-2”, which is a sub part inside of this unit part, is the recommended sub part, the replacement record ratio is calculated using a number of replacement records from which the records for the “Sub 2-2”, which was determined to the recommended sub part, have been removed. Furthermore, with respect to the “Sub 2-2”, which has been determined to be the recommended sub part, the replacement record ratio is calculated based on the number of replacement records for the sub part by itself. Note that in a case in which during S408, there is a plurality of parts that have been determined to be recommended sub parts for each of a plurality of unit parts, re-calculation of the replacement record ratio is performed for all of these unit parts.

During S410, the degree of priority determining unit 314 defines the degree of priority for a repair part. The degree of priority determining unit 314 determines the degree of priority for a repair part based on the determination results from S408 and the results of the re-calculation from during S409. The degree of priority for a repair part is made the descending order for the replacement record ratios in the market. Therefore, in a case in which no parts exist that have been determined to be recommended sub parts during S408, the degree of priority is defined only for the unit parts. In contrast, in a case in which a part exists that has been determined to be a recommended sub part, the degree of priority is defined for the recommended sub parts in addition to the unit parts.

During S411, the degree of priority determining unit 314 defines the degree of priority for estimated procedures based on the procedure records from the market. The degree of priority determining unit 314 acquires a market procedure record from the market procedure record that is managed by the market record management unit 315 for which the model number and the error code match the model number and the error code for the error information. In addition, the degree of priority determining unit 314 calculates the ratio per procedure for replacing, cleaning, and adjusting for the procedure records that have been acquired, and performs a ranking corresponding to the degrees of priority. For example, it is made such that the procedures for which the difference from the procedures with the highest ratio is less than 5% are made rank A, the procedures for which the difference from the procedures with the highest ratio is less than 20% are made rank B, and the procedures for which the difference from procedures with the highest ratio is 20% or greater are made rank C. For example, it is assumed that the model number that is included in the error information is “model-001”, and the error code that is included in the error information is “E001-0001”. In this case, the degree of priority determining unit 314 acquires the records for the fifth row from the top of Table 5 to serve as the market procedure record. In addition, the degree of priority determining unit 314 performs a ranking that corresponds to the degree of priority on the estimation results for the procedures based on the market procedure records that have been acquired.

Depending on the part, there are parts for which the procedures that can be executed are limited, such as parts for which cleaning or adjustment are not options and for which in the case in which a procedure is executed, replacement is the only option. Therefore, during S412 and S413, the combinations of processing that cannot be executed on each part are removed. During S412, the aggregate filter unit 316 verifies the correctness of the combinations of repair parts and procedures, and determines whether or not there are any incorrect combinations. Combinations are defined in advance for logically correct procedures in the correct master that is managed by the correct master management unit 317 per each model information, error code, and part of a device. Combinations of repair parts and procedures that were specified during the repair part estimation processing are verified according to the definitions of the correct master management unit 317, and combinations of repair parts and procedures that are not logically correct are confirmed. For example, in a case in which any of the procedures of “replacing”, “cleaning”, and “adjusting” cannot exist for a part, the procedures that cannot exist are procedures that are logically incorrect. t. The aggregate filter unit 316 determines that combinations for which definitions do not exist in the correct master management unit 317 are logically incorrect repair parts. In a case in which a combination of a repair part and a procedure is logically incorrect, the processing for S413 is performed. In contrast, the aggregate filter unit 316 determines that combinations for which definitions exist in the correct master management unit 317 are logically correct repair parts. In a case in which a combination of a repair part and a procedure is logically correct, the processing for S414 is performed.

During S413, the aggregate filter unit 316 filters and removes (deletes) combinations of repair parts and procedures that are not logically correct. The state in which the processing for S412 and S413 has been completed for all of the parts on the repair part list is the estimation results shown in Table 7 that combines the degree of priority (Table 4) for the repair parts and the procedures (Table 6). During S414, the degree of priority determining unit 314 registers the estimation results in the estimation results management unit 318. The estimation results include the degree of priority, the device ID, the error code, the part number, the number of part replacements, which shows the replacement record, the probability of being the cause of the error, and the degree of priority for each procedure (replacing, cleaning, and adjusting) for a part. Due to the above explained processing, the repair location notification server 101 is able to perform estimation of repair parts that are recommended (unit parts and sub parts) and procedures for these parts based on numbers of replacement records for resolving an error for the error that has occurred in the printer 102.

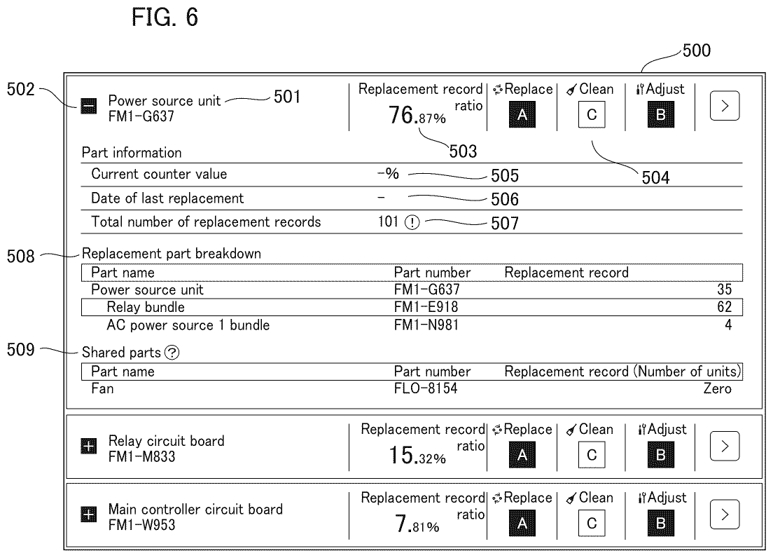

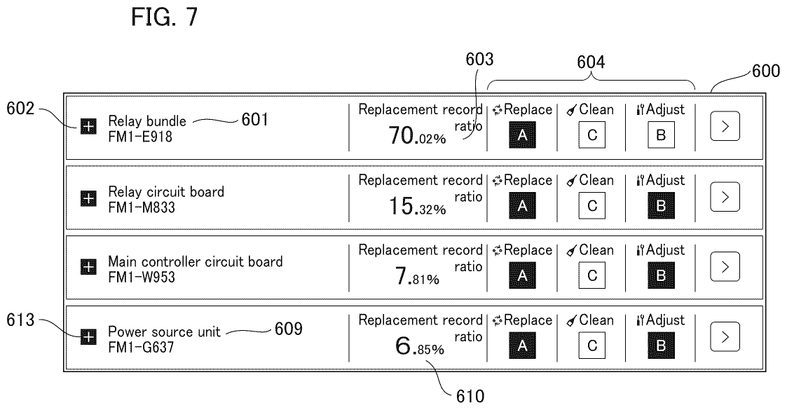

Upon receiving a display request for the procedure that has been estimated in order to resolve the error from the browser 331 of the PC 103, the repair process display unit 319 provides information based on the estimation results (Table 7) that have been registered in the estimation results management unit 318, and displays the recommended procedures screen. At this time, the information that is provided to the PC 103 by the repair process display unit 319 includes the one or more corresponding locations for which it has been estimated that a procedure is recommended in the printer 102, and the procedure contents for each of these one or more corresponding locations. The recommended procedure screen shows the repair part and the procedure for resolving the error that has occurred at the unit of an error. FIG. 6 to FIG. 9 are examples of recommended procedure screens that are displayed on the browser 331. From among these, FIG. 6 shows a UI for a case in which there is no recommended sub part (a case in which it has been determined during the determination of S408 of the repair location estimation processing flow that there are no recommended sub parts). In contrast, FIG. 7 to FIG. 9 show UIs for cases in which there are recommended sub parts (cases in which it has been determined during the determination of S408 of the repair location estimation processing that there are recommended sub parts).

FIG. 6 is a diagram showing one example of a recommended procedure screen for a case in which there are no recommended sub parts. The estimation results and the repair process, which are managed in the repair location notification server 101, for the error that has been indicated from the browser 331 are displayed on the recommended procedure screen 500. The recommended procedure screen 500 includes a collapse 502, a part name 501, a replacement record ratio 503, and a procedure rank 504. The part name 501 displays the name and part number of the part for the corresponding location for which it has been estimated that a procedure is recommended. In FIG. 6, in which there are no recommended sub parts, the names and part numbers for unit parts are displayed in the unit name 501. In the example that is shown in FIG. 6, as the part names for the part name 501, “power source unit”, “relay circuit board”, and “main controller circuit board” are displayed. Each part is displayed in the order of the highest replacement record ratio.

The replacement record ratio 503 displays the replacement record ratio for a unit part. The replacement record ratio shows the probability of this part being the cause of the damage based on market records. In a case in which there are no recommended sub parts, the replacement record ratio for a unit part displays the total replacement record ratio including all of the replacement record ratios for the sub parts that belong to this unit part. Note that it may also be made such that in a case in which the replacement record ratio is equal to or less than a predetermined ratio, “low possibility” is displayed instead of a numerical value showing the ratio.

The procedure rank 504 displays the degree of priority for the procedure contents that are recommended. The degrees of priority for “replacing”, “cleaning”, and “adjusting” are displayed in the procedure rank 504 using, for example, the icons “A”, “B”, “C”, and “-” based on the procedure rank for the recommended procedure estimation results that are managed by the estimation results management unit 318. The display of “-” shows a case in which this procedure does not exist for a part. That is, “-” is displayed for the procedures that have been removed during the filtering processing for S413. In the example of the power source unit that is shown in FIG. 6, replacing is assigned A, cleaning is assigned C, and adjusting is assigned B. It may also be made such that the background color of each icon that shows a procedure rank changes in cases in which a procedure is defined as correct and cases in which a procedure is defined as incorrect. For example, in a case in which a procedure is defined as correct, in the same manner as the “A” for replacing, color is added such that it easy to catch the user's eye. In contrast, in a case in which a procedure is defined as being incorrect, in the same manner as the “C” for cleaning, color is not added such that this does not stand out.

The collapse 502 is a button for expanding detailed information for a repair part. By the user selecting the collapse button 502 and expanding the detailed information, the detailed information for this unit part is displayed. The detailed information includes, for example, part information, a breakdown of the replacement part, and shared parts. The part information includes the counter value 505, a previous replacement date 506, and a total number of replacement records 507. The counter value 505 is the current counter information for the unit part. The previous replacement date 506 is the date on which this part was last replaced. The total number of replacement records 507 is the total number of replacement records for the unit part, that is, the total number of replacement records for the totals of the unit part itself and the sub parts inside of the unit part. The replacement part breakdown 508 displays the sub parts that belong to just the unit part that is displayed in the part name 501. In the example that is shown in FIG. 6, “relay bundle” and “AC power source 1 bundle” are shown in the replacement part breakdown 508. The shared parts 509 displays the sub parts of the unit part that is being displayed that also belong to other unit parts. The replacement part breakdown 508 and the shared parts 509 display the part name, part number, and number of replacement records for a sub part. In addition, the recommended procedure contents may also be displayed in the replacement part breakdown 508 and the shared parts 509. By the user confirming the detailed information, it is possible to confirm the replacement records for sub parts within a unit part.

FIG. 7 to FIG. 9 are diagrams showing one example of recommended procedure screens for a case in which there is a recommended sub part. In a case in which there is a sub part for which a procedure is recommended, the repair process display unit 319 provides information to the PC 103 such that both the unit parts and the sub parts will be displayed independently at the same time as the corresponding locations. The recommended procedures screen 600 displays the estimation results and the repair processes that are managed by the repair location notification server 101 in relation to the error that has been indicated from the browser 331. The recommended procedure screen 600 includes a collapse 602, a part name 601, a replacement record ratio 603, and a procedure rank 604. The part name 601 shows the name and part number for the part for the corresponding location that has been estimated to have a recommended procedure. In FIG. 7 to FIG. 9, which are diagrams for when there is a recommended sub part, the part name 601 displays the names and part numbers for unit parts and sub parts. In the example that is shown in FIG. 6, the “relay bundle” is a sub part, and the “power source unit”, “relay circuit board”, and “main controller circuit board” are unit parts. The “relay bundle” is a sub part of the “power source unit”. In this manner, in a case in which there is a recommended sub part, the recommended sub part and the unit parts are both displayed independently from each other on the recommended procedure screen 600. Each part including the recommended sub part and the unit parts are displayed in order of the highest replacement record ratio.

The part name 601 displays the name and part number for a part. In FIG. 7, which is a diagram for when there is a recommended sub part, the part name 601 also displays the names and part numbers for sub parts in addition to the names and part numbers for unit parts. In the example that is shown in FIG. 7, the “relay bundle” is displayed as the part name for the sub part in the part name 601, and is displayed independently from the “power source unit”, which is displayed as the part name for the unit part in the part name 609.

The replacement record ratio 603 displays the replacement record ratios for the sub parts. The replacement record ratio 610 displays the replacement record ratios for the unit parts. The replacement record ratio shows the probability of being the cause of the damage based on market records. In a case in which there is a recommended sub part, the ratio taken up by only the number of replacement records for the sub part is displayed. The replacement record ratio for a unit part that has a recommended sub part displays the replacement record ratio after the number of replacement records for the recommended sub part has been subtracted from the number of replacement records for the unit part. For example, the replacement record ratio 610 displays the replacement record ratio for after the number of replacement records for the “relay bundle”, which has been isolated as the recommended sub part, has been subtracted from the number of replacement records for the “electrode unit” and the sub parts that belong to the “power source unit”. The replacement record ratio for the unit parts that do not have recommended sub parts shows the replacement record ratio in which the number of replacement records for the unit part and the number of replacement records for the sub parts that belong to the unit part have all been totaled together.

The procedure rank 604 displays the degree of priority for the recommended procedure contents. The recommended procedure 1007 displays the degree of priority for “replace”, “clean”, and “adjust” using, for example, the icons “A”, “B”, “C”, and “-” based on the procedure rankings from the recommended procedure estimation results that are managed by the estimation results management unit 318. The display of “-” is shown in a case in which this procedure does not exist for a part. That is, “-” is displayed for the procedures that were removed during the filtering processing of S413. The collapse 602 and the collapse 613 are buttons for expanding detailed information about a repair part.

In FIG. 6, the “electrode unit” has the highest replacement record ratio from among all of the unit parts, the replacement record ratio being 76.87%, and is displayed at the top of the list. In a case in which the “relay bundle”, which has a replacement record ratio of 70.02%, is the recommended sub part, the replacement record ratio for the unit part the “power source unit”, to which the sub part of the “relay bundle” belongs, and which this sub part has been isolated from, becomes 6.85%. The “power source unit” is therefore displayed below the main controller circuit board, which has a replacement record ratio of 7.81%. In addition, the “relay bundle” for which the replacement record ratio is 70.2% is displayed the highest among all of the parts. In this manner, in a case in which there is a sub part that takes up the majority of the records for a unit part, this sub part is displayed on the recommended procedures screen in the same manner as the unit parts. It is thereby possible for a user to understand that a procedure should be implemented for a part that is displayed without understanding if this part is a unit part or a sub part, in particular, that the procedure should be implemented for the part that has the highest replacement record ratio and that is displayed the highest on the screen, In addition, the number of replacement records for a unit part decreases when the number of replacement records for a sub part that is being treated as the recommended sub part are subtracted therefrom, thereby lowering the display order for this unit part, and therefore, it is possible to lower the possibility that the user will think to replace the unit part.

The procedures for each part display procedure information that has been defined for each part by the correct master. Therefore, replace and adjust are displayed using the background color for procedures that have been defined as being correct as the procedures for the unit part of the “power source unit”. In contrast, only replace is displayed using the background color for procedures that have been defined as being correct as the procedures for the sub part of the “relay bundle”, and adjust is displayed using the background color for procedures that have been defined as being incorrect. In this manner, by independently displaying the sub part, it becomes possible to clearly display to the user what procedures are possible for a sub part and what procedures are not possible for a sub part.

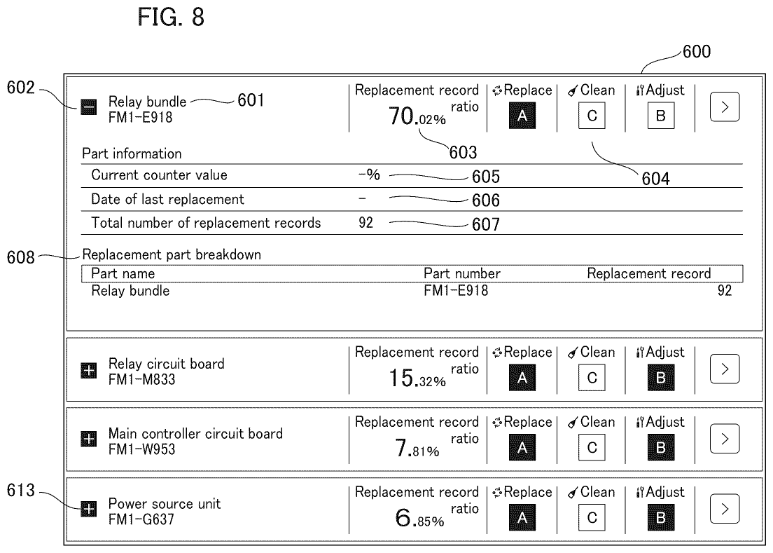

FIG. 8 is a diagram showing the detailed information for the recommended sub part. If the collapse button 602 is selected in the state that is shown in FIG. 7, the detailed information for the “relay bundle”, which is the sub part that is shown in FIG. 8, is expanded. The detailed information for a sub part shows the part information for this sub part. The part information for a sub part includes, for example, a counter value 605, a previous replacement date 606, and a total number of replacement records 607. The counter value 605 is the current counter information for the sub part. The previous replacement date 606 is the last date on which this part was replaced. The total number of replacement records 607 is the number of replacement records for the sub part. In addition, a breakdown of the replacement parts may also be included in the detailed information for a sub part. The breakdown of the replacement part includes the part name, part number, and replacement record for this sub part, and therefore, it is possible to confirm the part number. Although if the part that is displayed in the part name 601 is a unit part, the sub parts that belong to this unit part and the shared parts are also displayed in the replacement part breakdown 608, in a case in which the part that is displayed in the part name 601 is a sub part, this information is not displayed. In addition, the information for the unit part to which a sub part belongs may also be displayed in the detailed information for this sub part. It is thereby possible for the user to confirm to which unit part a sub part belongs.

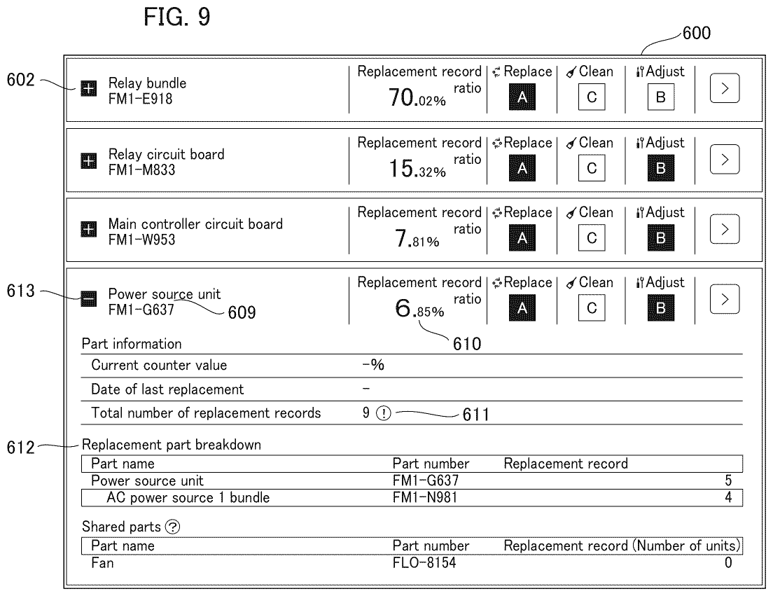

FIG. 9 is a diagram showing the detailed information for a unit part to which the recommended sub part belongs. Upon the collapse 613 being selected in the state that is shown in FIG. 7, the detailed information for the unit part “power source unit” that is shown in FIG. 9 is expanded. The detailed information for the unit part displays the part information, the replacement part breakdown, and the shared parts for this unit part. The part information includes the counter value, the previous replacement date, and the total number of replacement records 611. The total number of replacement records 611 displays a number in which the number of replacement records for the recommended sub part has been subtracted from the number of replacement records for the entirety of the unit part. In the example that is shown in FIG. 9, a number of replacement records in which the number of replacement records that is shown as the total number of replacement records 611 is the number in which the number of replacement records for the “relay bundle”, which is the is the sub part that has been isolated as the recommended sub part, has been subtracted from the number of replacement records for the “power source unit” and the sub parts that belong thereto is displayed in the total number of replacement records 611. The replacement part breakdown 612 displays the sub part that has been removed as the recommended sub part from among the sub parts that belong only to the unit part that is displayed in the part name 609. That is, the replacement part breakdown 612 does not display the sub part that has been independently displayed as the recommended sub part. In the example that is shown in FIG. 9, the replacement part breakdown 612 displays the “AC power source 1 bundle”, but does not display the “relay bundle”. The shared part 509 displays the sub parts that also belong to other unit parts in addition to the unit part that is being displayed. The replacement part breakdown and the shared part display the part names, part numbers, and number of replacement records for the sub parts. By confirming the detailed information, it is possible for the user to confirm the replacement records for sub parts inside of a unit part other than the recommended sub part. Note that although in the present embodiment it has been made such that the sub part that is independently displayed as the recommended sub part is not disclosed in the replacement part breakdown for the detailed information for a unit part, it may also be made such that this is disclosed therein. It is thereby possible for the user to understand the configuration of a unit part.

Note that although in the present embodiment an explanation has been given with the premise that an error has already occurred, the present disclosure is not limited thereto. For example, it is also possible to periodically collect the operation information of the printer 102, predict the indications of an event such as damage and the like, and perform maintenance before this event occurs. Therefore, the procedures for the printer 102 may also include procedures corresponding to events that have been indicated by the operation information in addition to procedures corresponding to errors. Upon acquiring the device ID from the PC 103, the repair location notification server 101 provides the estimation results for procedures that are recommended for responding to events that are indicated in the printer 102 corresponding to this device ID. It is also possible to display both the recommended sub part and the unit part at the same time in the same manner as in the present embodiment in the display of the part that is the procedure target for this maintenance (the corresponding location).

As has been explained above, according to the present embodiment, in a case in which there is a sub part that takes up the majority of the records for a unit part, it is possible to display both this sub part and the unit part on the recommended procedures screen. It is thereby possible for the user to understand that a procedure should be implemented for the displayed part without needing to understand whether this part is a unit part or a sub part. In particular, it is easier for the user to understand which part they should prepare and replace by comparing previous experiences and if a sub part for which there is a large number of replacement records is displayed as a sub part than if this sub part is displayed as a unit part with a low number of replacement records. In addition, by displaying this as a sub part, it is possible to exclude procedures that are not possible when narrowed down to a sub part from the selection of procedures to be implemented. By having the user understand the procedure to the sub part as being the first selection, it is possible for the user to implement the procedure to this sub part, which is a portion of the unit part, instead of to the unit part, which includes a plurality of sub parts, and it is possible to reduce the replacement costs and environmental burdens. In this manner, by displaying the sub parts for which there is a high possibility that a procedure should be implemented in addition to the unit parts based on the market records, it becomes possible for the maintenance worker to clearly understand for which part the procedure should be implemented.

### Second Embodiment

In the First Embodiment, in a case in which a large portion of the replacement records for a unit part are taken up by a particular sub part, display was performed by defining this sub part as the recommended sub part and displaying it independently on the recommended procedures screen. However, due to differences in the amount of knowledge that a user has relating to part information, as well as an actual desire to replace the unit part rather than replacing the sub part, there are also cases in which the user would like to be given suggestions for the repair part at the unit of a unit part. In addition, due to a desire to perform a repair by replacing a unit part, which can be finished with a simpler operation, and can shorten the maintenance time, there are also cases in which the user would like to be given suggestions for the repair part at the unit of a unit part. In this context, in the Second Embodiment, the display of the recommended sub part from the First Embodiment is made an optional function.

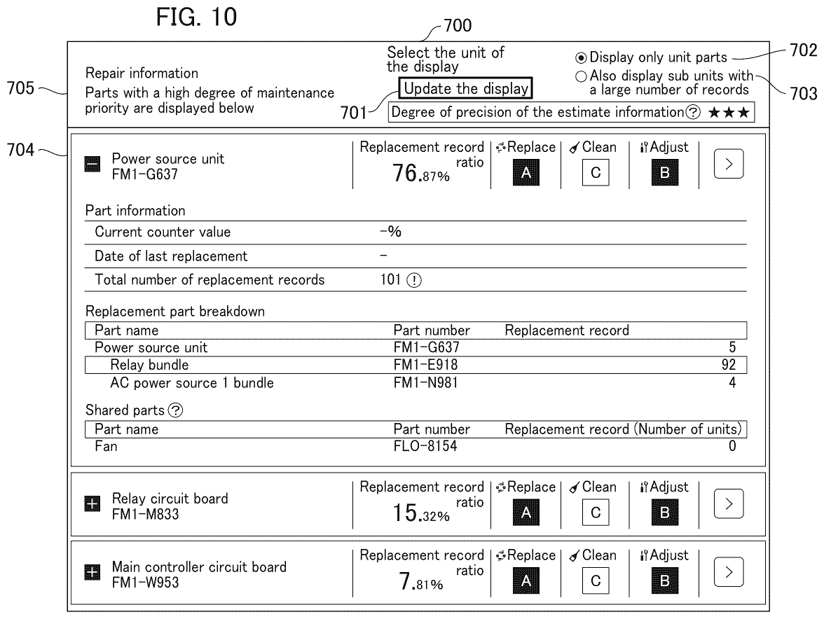

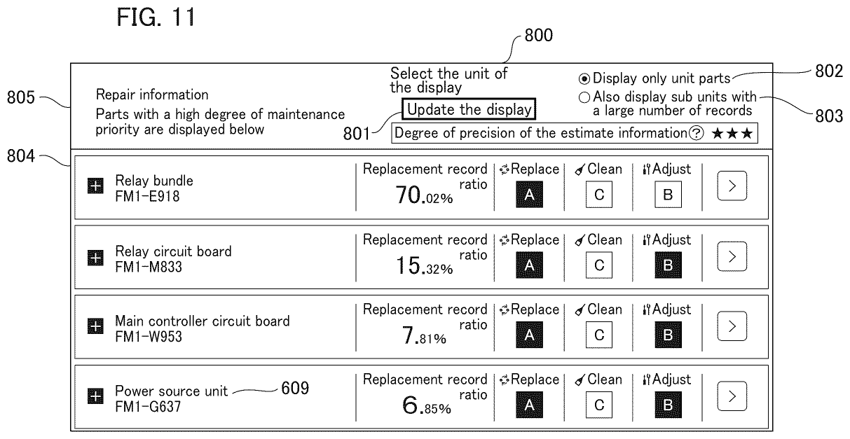

An example of a recommended procedure screen for a case in which the function to display a recommended sub part has been made optional will be explained using FIG. 10, and FIG. 11. FIG. 10 is a diagram showing one example of a recommended procedure screen for a case in which there is no recommended sub part in the Second Embodiment. The recommended procedure screen 700 includes a display unit selection area 705 and a recommended processing display area 704. The display unit selection area 705 displays a display update button 701, a check box 702, and a check box 703. The display update button 701 is a button for updating the display of the recommended processing display area 704. The check box 702 is a check box that is selected when display will be performed by limiting the display to only unit parts. The check box 703 is a check box that is selected when display will be performed of both the unit parts and the recommended sub parts. For example, upon the user selecting the check box 702 and pressing the display update button 701 in a state in which the recommended sub part is being displayed independently, the display of the recommended processing display area 704 will be updated to a display of just the unit parts. The display contents for the recommended processing display area 704 when only the unit parts are displayed are the same as the contents of the recommended procedure screen that is displayed in FIG. 6.

FIG. 11 is a diagram showing one example of a recommended procedure screen for a case in which there is no recommended sub part in the Second Embodiment. The recommended procedure screen 800 includes a display unit selection area 805 and a recommended processing display area 804. The display unit selection area 805 displays a display update button 801, a check box 802, and a check box 803. The display update button 801, the check box 802, and the check box 803 in FIG. 11 are respectively the same as the display update button 701, the check box 702, and the check box 703 of FIG. 10. If the user selects the check box 803 and presses the display update button 801 in a state in which the recommended sub parts are not being independently displayed, the display of the recommended processing display area 804 is updated to a display that also includes the recommended sub parts. The display contents of the recommended processing display area 804 that are displayed based on the recommended sub parts and the unit parts are the same as the recommended procedure screen that is shown in FIG. 7.

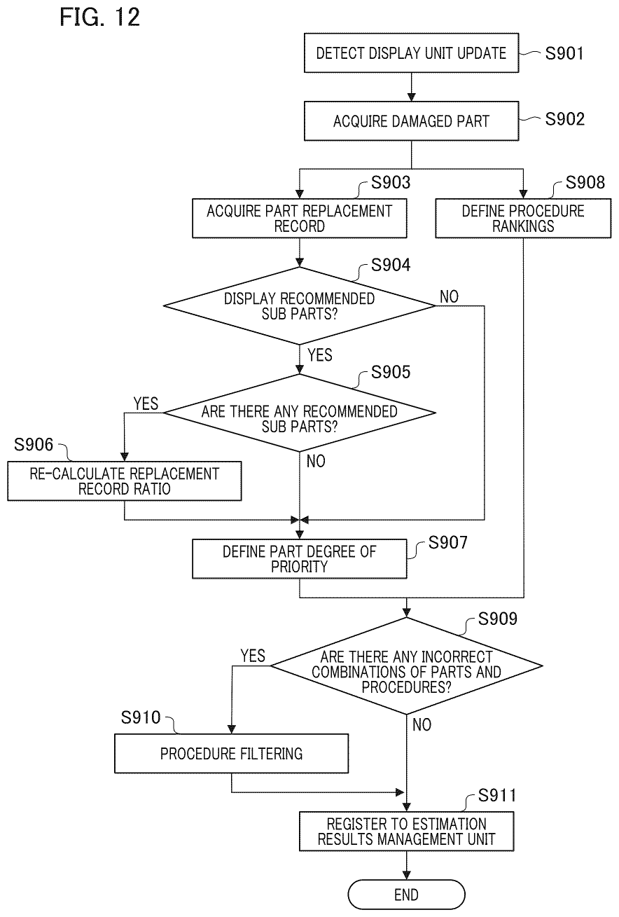

FIG. 12 is a flowchart showing display unit change processing in the Second Embodiment. Below, the points that are different from the recommended procedure estimation processing in the First Embodiment will be explained. During the display unit change processing, the processing that is executed by the repair location notification server 101 is realized by the CPU 201 of the repair location notification server 101 reading out a program and resource data that have been stored on a memory (the ROM 202, the HDD 204, and the like) and executing the program. In the case of the display unit change processing, the processing is being executed for an error for which the repair location estimation processing that was explained in the First Embodiment (FIG. 4, and FIG. 5) has been completed, and therefore, this is a state in which the estimation for the repair product that was executed during S406 in FIG. 4 has been executed, and the data (the estimation results for the repair product) is also stored. The present processing begins by it being detected that the display update button on the recommended procedure screen that is displayed on the PC 103 via the browser 331 has been pressed by the user.

During S901, the repair process display unit 319 detects a change instruction for the unit of the display. Specifically, the repair process display unit 319 detects a change event for the unit of the display for which the trigger was the pushing down of the display update button on the recommended procedures screen. During S902, the degree of priority determining unit 314 acquires information for a damaged part that was estimated during S406. During S903, the degree of priority determining unit 314 acquires the part replacement record. The processing for S903 is the same as the processing for S407.

During S904, the degree of priority determining unit 314 performs a determination as to whether or not to display the recommended sub part. The degree of priority determining unit 314 acquires the update contents for the unit of the display that were detected during S901, and determines whether or not to display the recommended sub part. In a case in which when the display update button has been pushed down, the check box for displaying only unit parts has been selected, it is determined that the recommended sub part will not be displayed, and the processing for S907 is performed. In contrast, in a case in which when the display update button has been pushed down, the check box for displaying both unit parts and recommended sub parts has been selected, it is determined that the recommended sub part will be displayed, and the processing for S905 is performed. The processing from S905 until S911 is the same as the processing for S407 to S414 in the First Embodiment, and therefore, an explanation thereof will be omitted.

Note that in the present embodiment, although a function for switching whether or not the display includes the recommended sub part was added to the recommended procedure screen, this may also be added to a management screen that can only be operated by a specific manager, and this may also be made a design in which only the manager can operate the function for switching whether or not the display includes the recommended sub part. In addition, it may also be made such that information showing the degree of precision of the estimated information (for example, a number of star marks) is displayed on the recommended procedure screen.

As was explained above, according to the present embodiment, by displaying sub parts for which there is a high possibility that a procedure should be implemented thereto in addition to the unit parts based on the market records, it becomes possible for the person who is performing the maintenance to clearly understand on which part the procedure should be performed. Furthermore, in a case in which the user does not wish to display a recommended procedures screen including recommended sub parts, it becomes possible to switch the display to a display of only the unit parts.

### Third Embodiment

In the First Embodiment and the Second Embodiment, the recommended sub part was determined based on the number of replacement records. However, in a case in which the determination of whether or not a sub part is a recommended sub part relies only on the number of replacement records, it is not possible to reflect the opinions of the device manufacturer. For example, periodic maintenance is necessary for parts that are often subjected to a heavy load, and there are also parts that are treated as a recommended sub part on the device manufacturer's side, but that are classified as sub parts that are included in unit parts during the estimation for the procedures due to the configuration of the parts. There are cases in which even if the device manufacturer understands the necessity of part maintenance for such parts, the system cannot determine such a part to be a recommended sub part based on the market records. In this context, in the Third Embodiment, it is made possible to reflect the parts that are recommended by the device manufacturer side and the like in the estimation of the parts for which a procedure is recommended in the recommended procedure estimation processing.

In the present embodiment, a recommended sub part is defined in advance in the correct master. Table 8 is an example of the recommended sub parts that have been defined in the master. For example, the recommended sub parts are defined in advance in the correct master that is managed by the correct master management unit 317.

TABLE 8

| Model | Error | Part | | | | Recommended |
|---|---|---|---|---|---|---|
| Number | Code | Number | Replace | Clean | Adjust | Sub Part |
| Model- | E001- | Unit1 | 1 | 1 | | |
| 001 | 0001 | | | | | |
| Model- | E001- | Sub 1-1 | 1 | | | |
| 001 | 0001 | | | | | |
| Model- | E001- | Sub 1-2 | | 1 | | |
| 001 | 0001 | | | | | |
| Model- | E001- | Sub 1-3 | 1 | 1 | | 1 |
| 001 | 0001 | | | | | |
| Model- | E001- | Unit 2 | 1 | 1 | 1 | |
| 001 | 0001 | | | | | |
| Model- | E001- | Sub 2-1 | | 1 | | 1 |
| 001 | 0001 | | | | | |
| Model- | E001- | Sub 2-2 | 1 | | | |
| 001 | 0001 | | | | | |
| Model- | E001- | Sub 2-3 | 1 | | 1 | |
| 001 | 0001 | | | | | |
| Model- | E001- | Unit 3 | | 1 | 1 | |
| 001 | 0001 | | | | | |

The master includes the model number, the error code, the part number, the procedure, and the recommended sub part. The part number discloses a part number for a part that will become a candidate for being the repair part in relation to the combination of a model number and an error code. As the part numbers, unit parts show “Unit”, and sub parts show “Sub”. If a procedure is a possible procedure for a part, “1” is disclosed in the procedure column, and if this procedure is not possible for this part, the procedure column is left blank. In addition, the recommended sub part is an item for defining the recommended sub part, and sub parts that should be displayed as recommended sub parts have “1” disclosed in the recommended sub part column. That is, the parts corresponding to the records for the 4^{th} row and the 6^{th} row, for which the recommended sub part is “1” are parts that have been recommended on the device manufacturer's side and the like. The other records, for which the recommended sub part column has been left blank, are the correct master key that was used in the First Embodiment and the Second Embodiment, in which the combinations of logically correct parts and procedures had been defined. The sub parts for which the recommended sub part column has been defined as “1” in advance in the correct master are treated as recommended sub parts when calculating the estimation results from the market record.

In a case in which the market record is table 3 and the correct master including the definitions for the recommended sub parts is table 8, if the parts for which a procedure in order to resolve the error is recommended and the procedure contents are estimated by executing the recommended procedure estimation processing, the estimation results that are shown in Table 9 are managed by the estimation results management unit 318. Table 9 is the estimation results in the Third Embodiment.

TABLE 9

| | | | | | Probability | | | |
|---|---|---|---|---|---|---|---|---|
| | | | | | of Being | | | |
| Degree | | | | Number of | the Cause | | | |
| of | Device | Error | Part | Replacements | of the | | | |
| Priority | ID | Code | Number | per Part | Damage | Replace | Clean | Adjust |
| 2 | DEV001 | E00- | Unit 1 | 127 | 21.6% | A | B | — |
| | | 0001 | | | | | | |
| | DEV001 | E00- | Sub 1-1 | 8 | | | | |
| | | 0001 | | | | | | |
| | DEV001 | E00- | Sub 1-2 | 20 | | | | |
| | | 0001 | | | | | | |
| 4 | DEV001 | E00- | Sub 1-3 | 74 | 10.3% | A | B | — |
| | | 0001 | | | | | | |
| 6 | DEV001 | E00- | Unit 2 | 7 | 1.4% | A | B | A |
| | | 0001 | | | | | | |
| 5 | DEV001 | E00- | Sub 2-1 | 21 | 2.9% | — | B | — |
| | | 0001 | | | | | | |
| 1 | DEV001 | E00- | Sub 2-2 | 349 | 48.7% | A | — | — |
| | | 0001 | | | | | | |
| | DEV001 | E00- | Sub 2-3 | 3 | | | | |
| | | 0001 | | | | | | |
| 3 | DEV001 | E00- | Unit 3 | 108 | 15.1% | — | B | A |
| | | 0001 | | | | | | |

Each item that is shown in Table 9 is the same as the items shown in Table 7. If the estimation is executed based on the market record, and Table 8, which defines “Sub 1-3”, and “Sub 2-1” as the recommended sub parts, both the “Sub 1-3” and the “Sub 2-1” are determined to be recommended sub parts, and the calculation of the replacement record ratio and the degree of priority ranking are performed individually for the “Sub 1-3” and the “Sub 2-1”. In addition, the “Sub 2-2”, for which there is a large number of records, is also determined to be a recommended sub part, and the calculation of the replacement record ratio and the degree of priority ranking is also performed for the “Sub 2-2”.

In a case in which, as for the sub part (“Sub 2-1”) that belongs to the “Unit 2”, a sub part exists that has been defined as a recommended sub part in the master, the determination for the recommend sub part according to the number of replacement records is performed by removing the records for the parts that have been defined as recommended sub parts in the master. For example, in the case of the “Unit 2” and the sub parts that belong to the “Unit 2”, when the number of replacement records for the “Sub 2-2” of 349 is totaled together with the number of replacement records for the “Unit 2” of 7 +the number of replacement records for the “Sub 2-3” of 3 this becomes 359, and in relation to this, 349/359=97.2%. Therefore, it can be determined that this sub part “Sub 2-2” is the recommended sub part. The UI display for the recommended procedure screen based on the estimate results is the same as the cases shown in FIG. 7 to FIG. 9.

As was described above, according to the present embodiment, it is possible to define the recommended sub parts in advance. It thereby becomes possible to treat the parts that the device manufacturer side and the like would like to treat as recommended sub parts that are the target of the procedure as the recommended sub parts during the estimation processing.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072296, filed April 26 2024, which is hereby incorporated by reference wherein in its entirety.

What is claimed is:

1. An information provision system providing information relating to a procedure for an image forming apparatus, the information provision system comprising:
a memory storing instructions; and
a processor executing the instructions causing the information processing system to:
provide information including one or more corresponding locations in the image forming apparatus for which it has been estimated that a procedure is recommended, and procedure contents for the procedure with respect to the one or more corresponding locations,
wherein provision of information is performed such that a unit part for which the procedure is recommended, and a sub part for which the procedure is recommended and that is included in the unit part are both displayed independently as the corresponding locations.

2. The information provision system according to claim 1, wherein the sub part for which a procedure is recommended that is displayed independently from the the unit parts is determined based on ratios of numbers of records for processing for the sub part in comparison to numbers of records for processing for the unit part and all sub parts that are included in the unit part.

3. The information provision system according to claim 1, wherein the processor further executes an instruction causing the information provision system to estimate the recommended corresponding locations and the procedure for the image forming apparatus based on information that has been acquired from the image forming apparatus and records of past procedures,
wherein in a case in which a number of procedure records for a specific sub part that is included in a unit part exceeds a predetermined ratio in relation to a total number of procedure records of a number of procedure records for the unit part and a number of procedure records for all sub parts included in the unit part, it is estimated that the specific sub part is the sub part for which the procedure is recommended.

4. The information provision system according to claim 3, wherein in a case in which estimation is performed for a unit part that includes a sub part for which a procedure is recommended, estimation is performed by excluding records for procedures relating to the sub part for which processing is recommended from records for procedures relating to the unit part.

5. The information provision system according to claim 1, wherein ratios for replacement records corresponding to the corresponding locations are included in the information that is provided; and
in a case in which the corresponding locations for which the procedure is recommended are displayed based on the provision of the information, the corresponding locations are displayed in order of the highest ratios for the replacement records.

6. The information provision system according to claim 1, wherein the processor receives a selection of whether to limit the corresponding locations to only the unit part, or whether to make the corresponding locations both the unit part and the sub part, and provides information including the corresponding locations according to the selection, and procedure contents for each of the corresponding locations.

7. The information provision system according to claim 1, wherein the sub part for which the procedure is recommended and that is displayed independently from the unit part is sub part that has been defined in advance.

8. The information provision system according to claim 1, wherein the procedure for the image forming apparatus is a procedure for resolving an error that has occurred in the image forming apparatus, and a procedure for dealing with an event that is predicted from operational information for the image forming apparatus.

9. A control method for an information provision system providing information relating to a procedure for an image forming apparatus, the method comprising:
providing information including one or more corresponding locations in the image forming apparatus for which it has been estimated that a procedure is recommended, and procedure contents for the procedure with respect to the one or more corresponding locations,
wherein, in providing, provision of information is performed such that a unit part for which the procedure is recommended, and the sub parts for which procedure is recommended and that is included in the unit part are both displayed independently as the corresponding locations.
